(19) United States
(12) Patent Application Publication
(10) Pub. No.: US 2016/0163063 A1
(43) Pub. Date: Jun. 9, 2016

(54) MIXED-REALITY VISUALIZATION AND METHOD

(71) Applicant: Matthew Ashman, Bellevue, WA (US)

(72) Inventor: Matthew Ashman, Bellevue, WA (US)

(21) Appl. No.: 14/610,992

(22) Filed: Jan. 30, 2015

Related U.S. Application Data
(63) Continuation of application No. 14/561,167, filed on Dec. 4, 2014, now abandoned.

(51) Int. Cl. G06T 7/20; G06F 3/01

(52) U.S. Cl. CPC G06T 7/20; G06F 3/011

(57) ABSTRACT

Disclosed is a technique for providing a mixed-reality view to user of the visualization device. The device provides the user with a real-world, real-time view of an environment of the user, on a display area of the device. The device additionally determines a location at which a virtual reality window should be displayed within the real-world, real-time view of the environment of the user, and displays the virtual reality window at the determined location within the real-world, real-time view of the environment of the user. The device may additionally display one or more augmented reality objects within the real-world, real-time view of the environment of the user.

This is a continuation of U.S. patent application Ser. No. 14/561,167, filed on Dec. 4, 2014, which is incorporated herein by reference in its entirety.

### FIELD OF THE INVENTION

At least one embodiment of the present invention pertains to virtual reality (VR) and augmented reality (AR) display systems, and more particularly, to a device and method to combine VR, AR and/or real-world visual content in a displayed scene.

### BACKGROUND

Virtual Reality (VR) is a computer-simulated environment that can simulate a user's physical presence in various real-world and imagined environments. Traditional VR display systems display three-dimensional (3D) content that has minimal correspondence with physical reality, which results in a “disconnected” (but potentially limitless) user experience. Augmented reality (AR) is a live direct or indirect view of a physical, real-world environment whose elements are augmented (or supplemented) by computer-generated sensory input such as video, graphics, sound, etc. Current AR systems attempt to merge 3D augmentations with real-world understanding, such as surface reconstruction for physics and occlusion.

### SUMMARY

Introduced here are a visualization method and a visualization device (collectively and individually, the “visualization technique” or “the technique”) for providing mixed-reality visual content to a user, including a combination of VR and AR content, thereby providing advantages of both types of visualization methods. The technique provides a user with an illusion of a physical window into another universe or environment (i.e., a VR environment) within a real-world view of the user's environment. The visualization technique can be implemented by, for example, a standard, handheld mobile computing device, such as a smartphone or tablet computer, or by a special-purpose visualization device, such as a head-mounted display (HMD) system.

In certain embodiments, the visualization device provides the user (or users) with a real-world, real-time view (“reality view”) of the user's (or the device's) environment on a display area of the device. The device determines a location at which a VR window, or VR “portal,” should be displayed to the user within the reality view, and displays the VR portal so that it appears to the user to be at that determined location. In certain embodiments, this is done by detecting a predetermined visual marker pattern in the reality view, and locating the VR portal based on (e.g., superimposing the VR portal on) the marker pattern. The device then displays a VR scene within the VR portal and can also display one or more AR objects overlaid on the reality view, outside of the VR portal. In certain embodiments the device can detect changes in its physical location and/or orientation (or of a user holding/wearing a device) and correspondingly adjusts dynamically the apparent (displayed) location and/or orientation of the VR portal and the content within the VR portal. By doing so, the device provides the user with a consistent and realistic illusion that the VR portal is a physical window into another universe or environment (i.e., a VR environment).

The VR content and AR content each can be static or dynamic, or a combination of both static and dynamic content (i.e., even when the user/device is motionless). Additionally, displayed objects can move from locations within the VR portal to locations outside the VR portal, in which case such objects essentially change from being VR objects to being AR objects, or vice versa, according to their display locations.

Other aspects of the technique will be apparent from the accompanying figures and detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates an example of a mixed-reality display by a mixed-reality visualization device.

FIG. 2 shows an example of a target image for use in locating a VR window.

FIG. 3 illustrates the relationship between occlusion geometry and a VR image.

FIGS. 4A through 4D show examples of how the mixed reality visualization technique can be applied.

FIG. 5 shows an example of an overall process that can be performed by the mixed-reality visualization device.

FIG. 6 shows in greater detail an example of process that can be performed by the mixed-reality visualization device.

FIG. 7 is a high-level block diagram showing an example of functional components of the mixed reality visualization device

FIG. 8 is a high-level block diagram of an example of physical components of the mixed-reality visualization device.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

The technique introduced here enables the use of a conventional image display device (e.g., a liquid crystal display (LCD)), for example in an HMD or AR-enabled mobile device, to create a visual “portal” that appears as a porous interface between the real world and a virtual world, with optional AR content overlaid on the user's real-world view. This technique has advantages for (among other things) HMD devices, for example, since the dark background of the screen can provide an improved contrast ratio, which addresses the technical challenges for HMD devices that display AR content without occluding real world content in the background, e.g., because they have transparent or semi-transparent displays that only add light to a scene.

In certain embodiments the mixed-reality visualization device includes: 1) an HMD device or handheld mobile AR-enabled device with six-degrees-of-freedom (6-DOF) position/location tracking capability and the capabilities of recognizing and tracking planar marker images and providing a mixed reality overlay that appears fixed with respect to the real world; 2) an image display system that can display a target image and present a blank or dark screen when needed; and 3) a display control interface to trigger the display of the planar marker image on a separate display system. In operation the mixed-reality visualization technique can include causing a planar marker image to be displayed on a separate image display system (e.g., an LCD monitor) separate from the visualization device, recognizing the location and orientation of the planar marker image with the visualization device, and operating the visualization device such that the image display system becomes a porous interface or “portal” between AR and VR content. At least in embodiments where the visualization device is a standard handheld mobile device, such as a smartphone or tablet computer, the mixed VR/AR content can be viewed by multiple users simultaneously.

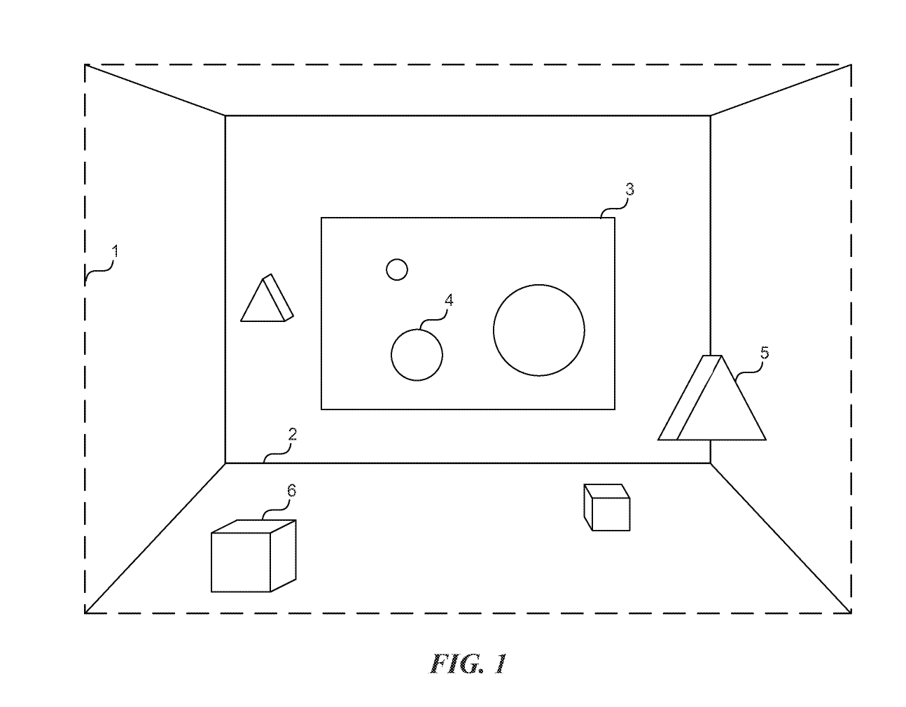

FIG. 1 conceptually illustrates an example of a display that a user of the visualization device may see, when the device employs the mixed-reality visualization technique introduced here. The outer dashed box in FIG. 1 and all other figures of this description represents the display area boundary of a display element of the visualization device (not shown), or alternatively, a boundary of the user's field of view. Solid lines 2 represent the intersections of walls, floor and ceiling in a room occupied by a user of the visualization device. It can be assumed that the user holds or wears the visualization device. In the display the user can see a reality view of his environment, including various real-world (physical) objects 6 in the room. At least where the visualization device is an HMD device, the display area may be transparent for semi-transparent, so that the user can view his or her environment directly through the display. In other embodiments, such as in a smartphone or tablet embodiment, the reality view provided on the display is from at least one camera on the visualization device.

The visualization device also generates and displays to the user a VR window (also called VR portal) 3 that, in at least some embodiments, appears to the user to be at a fixed location and orientation in space, as discussed below. The visualization device displays VR content within the VR window 3, representing a VR environment, including a number of VR objects 4. The VR objects 4 (which may be far more diverse in appearance than shown in FIG. 1) may be rendered using conventional perspective techniques to give the user an illusion of depth within the VR window 3. Optionally, the visualization device may also generate and display to the user one or more AR objects 5 outside the VR window 3. Any of the VR/AR objects 4 or 5 may appear to be in motion and may be displayed so as to appear to move into and out of the VR window 3.

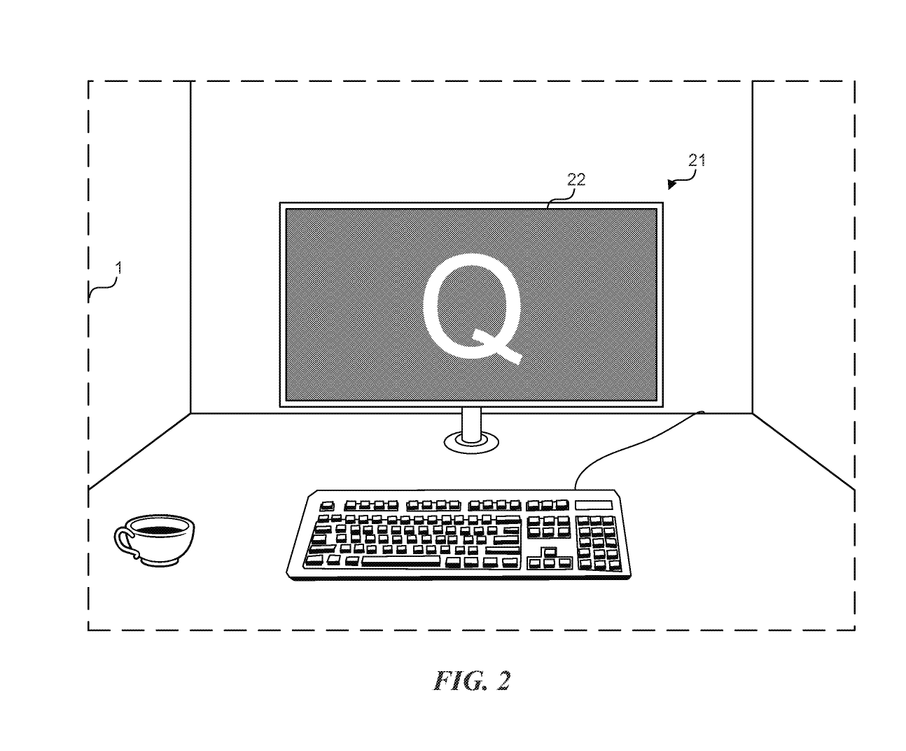

In some embodiments, the location and orientation of the VR window 3, as displayed to the user, are determined by use of a predetermined planar marker image, or target image. FIG. 2 shows an example of the target image. In FIG. 2, a conventional computer monitor 21 is displaying a target image 22. Note, however, that the monitor 21 is not part of the visualization device. In the illustrated example, the target image 22 is the entire (dark) display area of the monitor with a large letter “Q” on it. The “Q” image is advantageous because it lacks symmetry in both the horizontal and vertical axes. Symmetry can lead to ambiguity in the detected pose of the target image. Note, however, that the target image could instead be some other predetermined image, though preferably one that also has neither horizontal nor vertical symmetry. For example, a target image could instead be painted on or affixed to a wall or to some other physical object. Alternatively, a target image could be an actual physical object (as viewed by the camera on the visualization device). Furthermore, while the target image is fixed in the illustrated embodiment, in other embodiments the target image may physically move through the real-world environment. In either scenario, the visualization device may continuously adjusts the displayed location, size and shape of the VR window to account for the current position and orientation of the target image relative to the visualization device.

The visualization device uses the target image to determine where to locate and how to size and orient the VR window as displayed to the user. In certain embodiments the visualization device overlays the VR window on the target image and matches the boundaries of the VR window exactly to the boundaries of the target image, i.e., it coregisters the VR window and the target image. In other embodiments, the device may use the target image simply as a reference point, for example to center the VR window.

Additionally, the visualization device has the ability to sense its own location within its local physical environment and its motion in 6-DOF (i.e., translation along and rotation about each of three orthogonal axes). It uses this ability to modify the content displayed in the VR window as the user moves in space relative to the marker image, to reflect the change in the user's location and perspective. For example, if the user (or visualization device) moves closer to the target image, the VR window and VR content within it will grow larger on the display. In that event the content within the VR window may also be modified to show additional details of objects and/or additional objects around the edges of the VR window, just as a user would see more looking out a real (physical) window when the user is right up against the window then when the user is standing several away from it. Similarly, if the user moves away from the target image, the VR window and VR content within it grow smaller on the display, with VR content being modified accordingly. Further, if the user moves to the side so that the device does not have a direct (perpendicular) view of the planar target image, the visualization device will adjust the displayed shape and content of the VR window accordingly to account for the user's change in perspective, to maintain a realistic illusion that the VR window is a portal into another environment/universe.

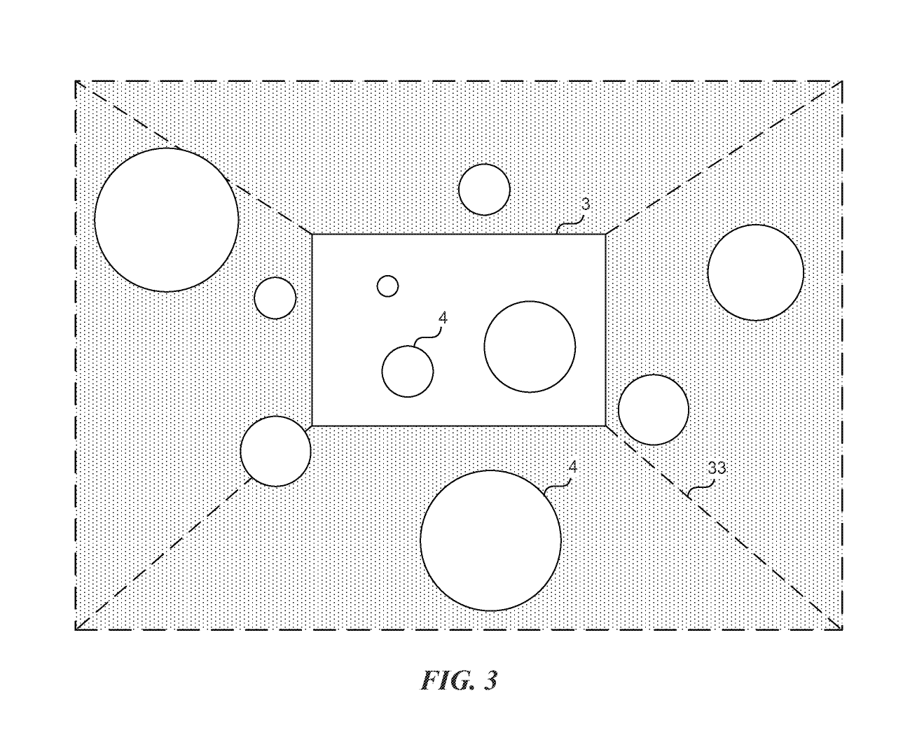

In certain embodiments, the VR content within the VR window is a subset of a larger VR image maintained by the visualization device. For example, the larger VR image may be sized at least to encompass the entire displayed area or field of view of the user. In such embodiments, the visualization device uses occlusion geometry, such as a mesh or shader, to mask the portion of the VR image outside the VR window so that that portion of the VR image is not displayed to the user. An example of the occlusion geometry is shown in FIG. 3, in the form of an occlusion mesh 31. The entire VR image includes a number of VR objects, but only those VR objects that are least partially within the VR window are made visible to the user, as shown in the example of FIG. 1.

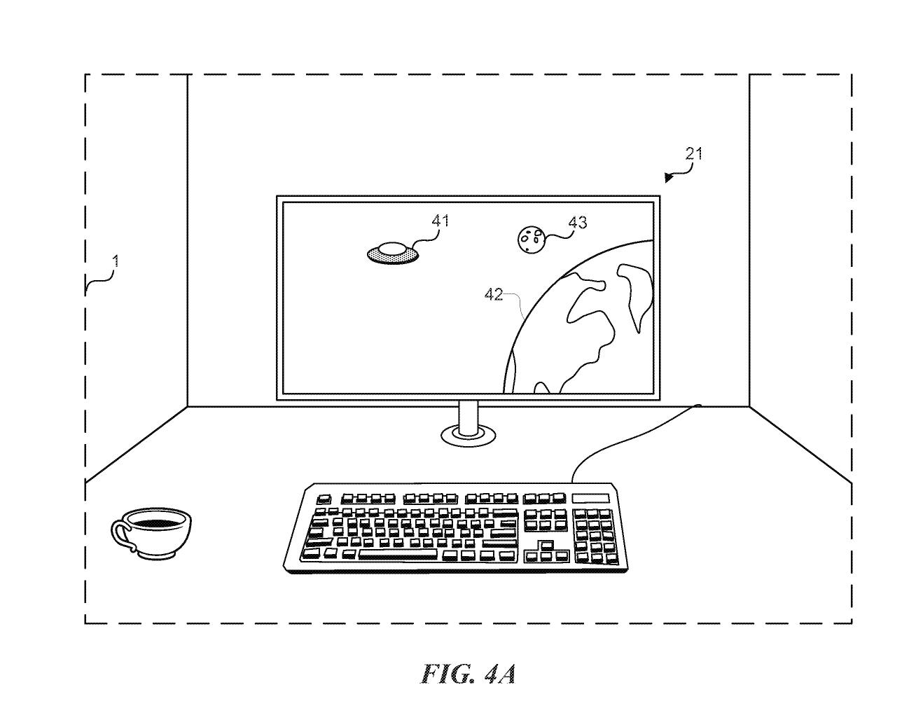

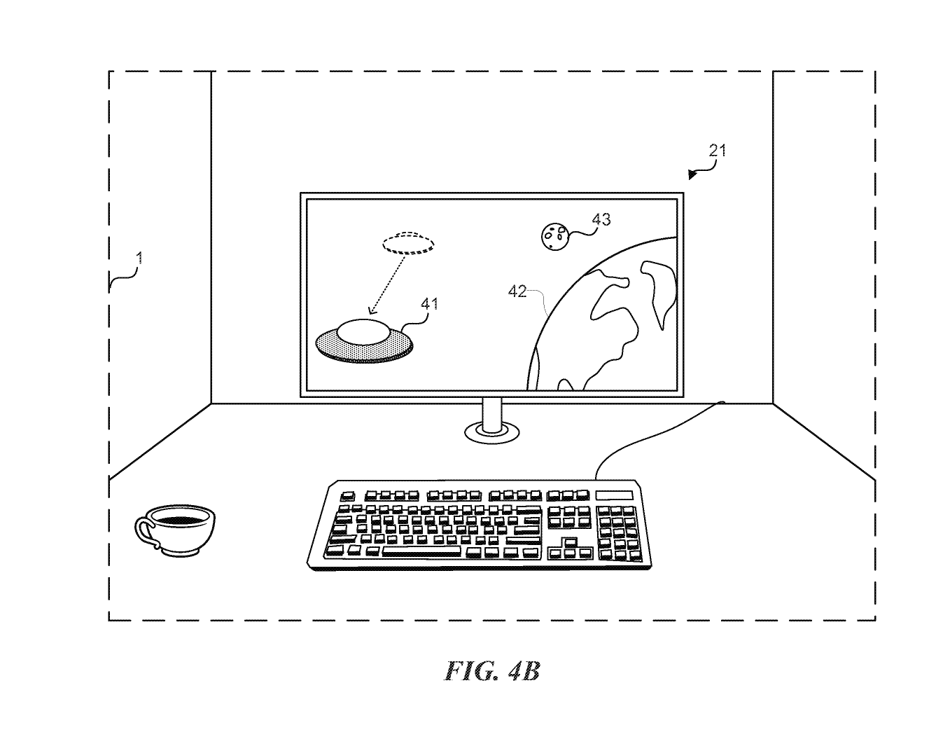

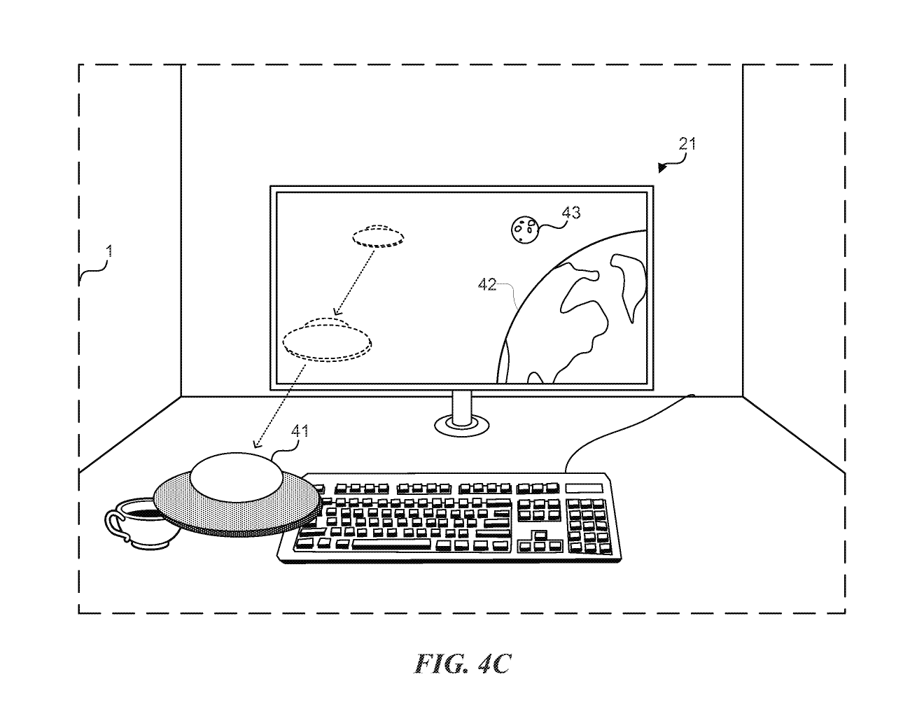

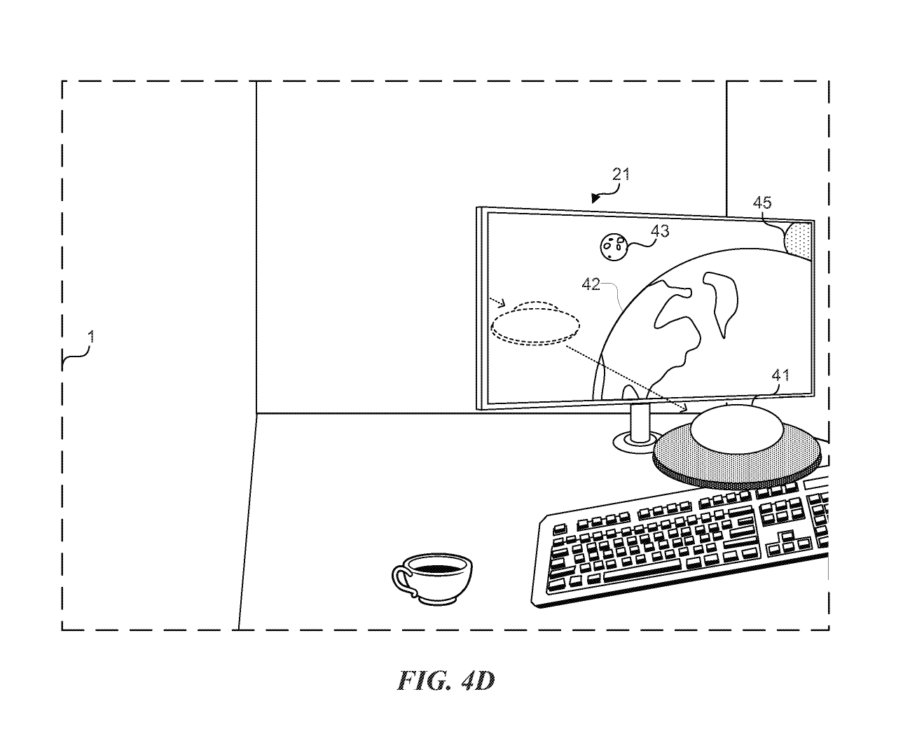

FIGS. 4A through 4D show slightly more complex examples of how the mixed-reality visualization technique can be applied. In FIG. 4, the visualization device has overlaid the VR window 40 containing a VR scene over the target image (not shown), such that the target image is no longer visible to the user through the display. The VR scene in this example includes a spaceship 41, a planet 42 and a moon 43. Hence, it should be understood that the VR scene is not actually generated by the monitor 21 (or a device connected to it), but is instead generated and displayed by the visualization device (not shown in FIGS. 4A through 4D) held or worn by the user. Nonetheless, the visualization device may have an appropriate control interface to trigger display of the target image, for example, by communicating with a separate device to cause that separate device to display the target image.

At least some of the VR objects 41 through 43 may be animated. For example, the spaceship 41 may appear to fly out of the VR window toward the user, as shown in FIGS. 4B and 4C (the dashed arrows and -- spaceship outlines are only for explanation in this document and are not displayed to the user). A displayed object or any portion thereof that is outside the boundaries of the VR window 40 is considered to be in an AR object rather than a VR object. There is no functional difference between AR objects and VR objects, however, nor is the user aware of any distinction between them, aside from their apparent locations on the display and apparent distances from the user. The rendering hardware and software in the visualization device can seamlessly move any VR object out of the VR window 40 (in which case the object becomes an AR object) and seamlessly move any AR object into the VR window 40 (in which case the object becomes a VR object).

FIG. 4D shows an alternative view in which the user is viewing the scene from a position farther to the user's left, so that the user/device does not have a direct (perpendicular) view of the planar target image. In this view, the shape of the VR window 40 and the VR content within it are modified accordingly, to maintain a realistic illusion that the VR window 40 is a portal into another environment/universe. In this example the user can now see, in the background of the VR window, another planet 45 that was hidden in the example of FIGS. 4A through 4C (where the user was viewing the image head-on), and also can see more of the first planet 42 in the foreground. Further, the spaceship 41 is now seen by the user (as an AR object) from a different angle. Additionally, the shape of the VR window 40 itself has changed to be slightly trapezoidal, rather than perfectly rectangular, to reflect the different viewing angle.

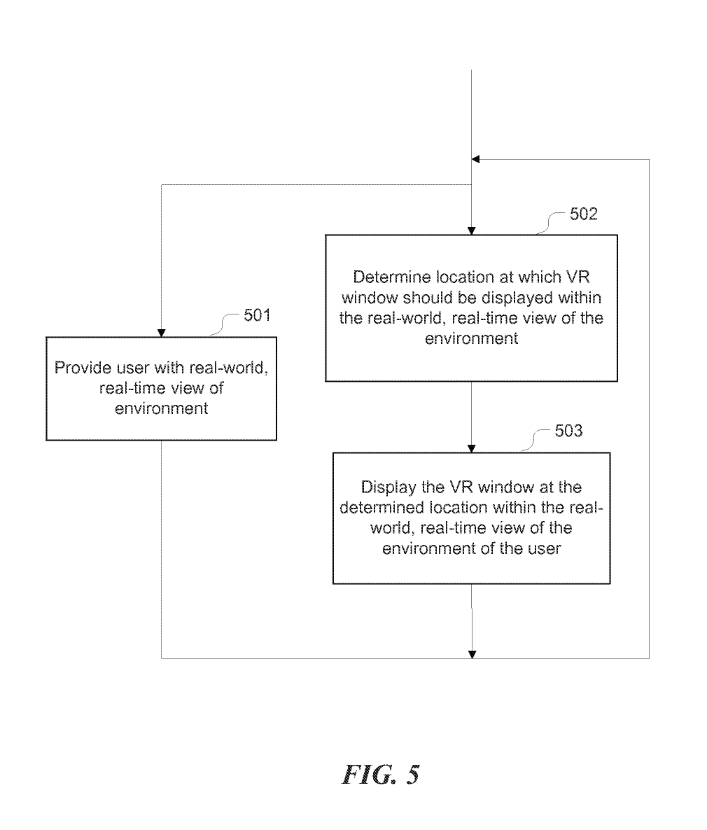

FIG. 5 shows an example of an overall process performed by the visualization device, in certain embodiments. At step 501, the device provides the user with a real-world, real-time view of his or her environment. This “reality view” can be a direct view, such as through transparent or semi-transparent display on an HMD device, or an indirect view, such as acquired by a camera and then displayed on a handheld mobile device. Concurrently with step 501, the device at 502 determines the location at which the VR window should be displayed within the real-world, real-time view of the environment, and at step 503 displays the VR window at that determined location. This process can repeat continuously as described above. Note that in other embodiments, the arrangement of steps may be different.

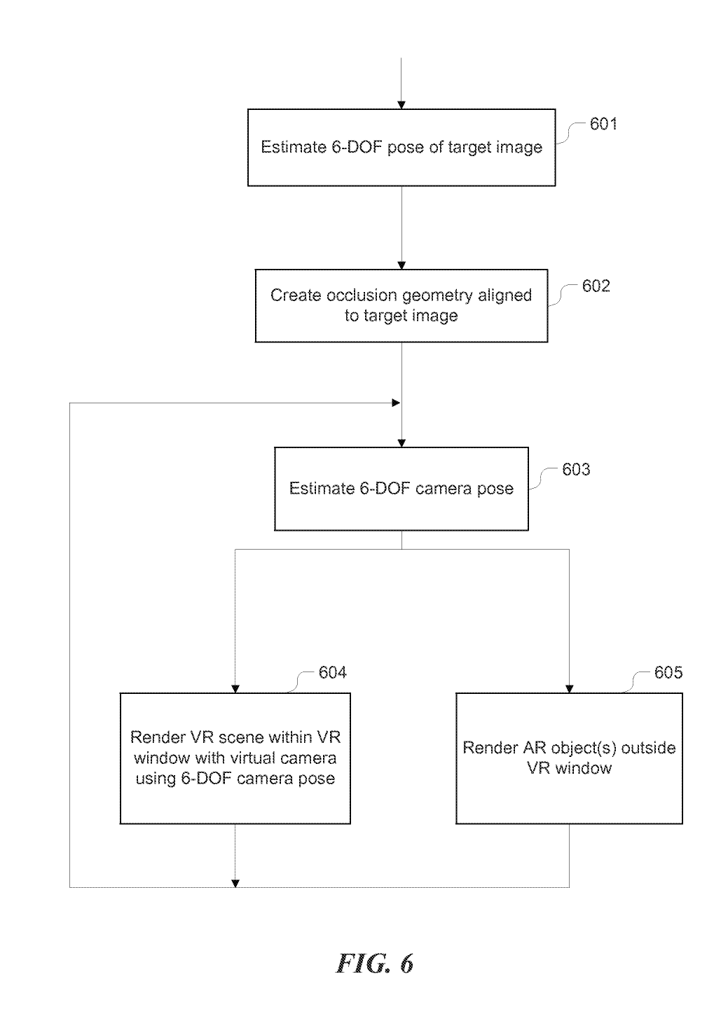

FIG. 6 shows in greater detail an example of the operation of the visualization device, according to certain embodiments. At step 601 the visualization device estimates the 6-DOF pose of the target image. The device then at step 602 creates occlusion geometry aligned to the target image, as described above. The occlusion geometry in effect creates the VR window. The device estimates its own 6-DOF camera pose at step 603, i.e., the 6-DOF location and orientation of its own tracking camera. In the illustrated embodiment, the device then renders a VR scene within the VR window with its virtual camera using the 6-DOF camera pose at step 604, while rendering one or more AR objects outside the VR window at step 605. Note that steps 604 and 605 can be performed as a single rendering step, although they are shown separately in FIG. 6 for the sake of clarity. Additionally, the sequence of steps in the process of FIG. 6 may be different in other embodiments. The 6-DOF camera pose is the estimated pose transformation from the target image's coordinate system to a coordinate system (rotation and translation) of a display camera (e.g., an RGB camera) on the visualization device, or vice versa. The center of the target image can be taken as a origin of the target image's coordinate system. The virtual camera is a rendering camera implemented by graphics software or hardware. The estimated 6-DOF camera pose can be used to move the virtual camera in the scene in front of a backdrop image from a live video feed, creating the illusion of a are content in the composed scene. The above-described process can then loop back to step 603 and repeat from that point continuously as described above.

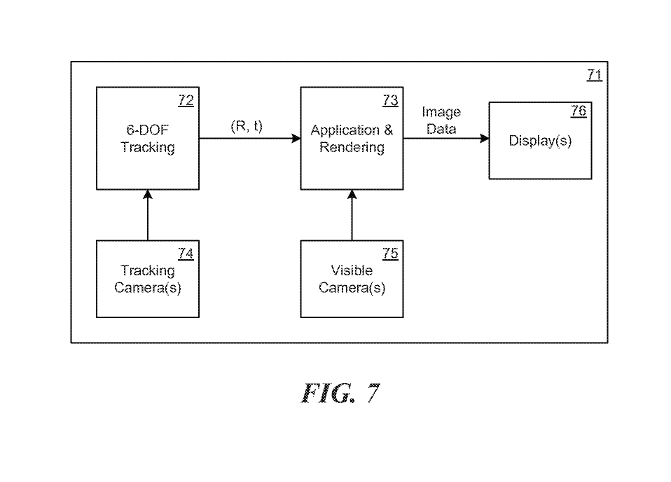

FIG. 7 is a high-level block diagram showing an example of certain functional components of the mixed-reality visualization device, according to some embodiments. The illustrated mixed-reality visualization device 71 includes a 6-DOF tracking module 72, an application rendering module 73, one or more tracking (video) cameras 74 and one or more display (video) cameras 75. The 6-DOF tracking module 72 receive inputs from the tracking camera(s) 74 (and optionally from an IMU, not shown) and continuously updates the camera pose based on these inputs. The 6-DOF tracking module 72 generate and outputs transformation data (e.g., rotation (R) and translation (t)) representing the estimated pose transformation from the target image's coordinate system to the display camera's coordinate system based on these inputs.

The application & rendering module 73 generates the application context in which the mixed-reality visualization technique is applied and can be, for example, a game software application. The application & rendering module 73 receives the transformation data (R,t) from the 6-DOF tracking module 72, and based on that data as well as image data from the display camera(s) 75, generates image data which is sent to the display device(s) 76, for display to the user. The 6-DOF tracking module 72 and application rendering module 73 each can be implemented by appropriately-programmed programmable circuitry, or by specially-designed (“hardwired”) circuitry, or a combination thereof.

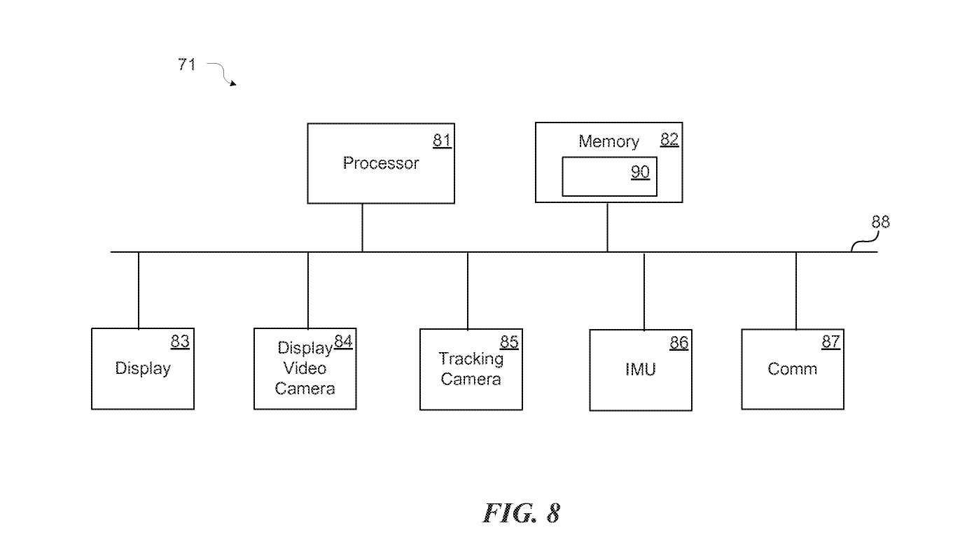

As mentioned above, the mixed-reality visualization device 71 can be, for example, an appropriately-configured conventional handheld mobile device, or a special-purpose HMD device. In either case, the physical components of such a visualization device can be as shown in FIG. 8, which shows a high-level, conceptual view of such a device. Note that other embodiments of such a visualization device may not include all of the components shown in FIG. 8 and/or may include additional components not shown in FIG. 8.

The physical components of the illustrated visualization device 71 include one or more instance of each of the following: a processor 81, a memory 82, a display device 83, a display video camera 84, a depth-sensing tracking video camera 85, an inertial measurement unit (IMU) 87, and communication device 87, all coupled together (directly or indirectly) by an interconnect 88. The interconnect 88 may be or include one or more conductive traces, buses, point-to-point connections, controllers, adapters, wireless links and/or other conventional connection devices and/or media, at least some of which may operate independently of each other.

The processor(s) 81 individually and/or collectively control the overall operation of the visualization device 71 and perform various data processing functions. Additionally, the processor(s) 81 may provide at least some of the computation and data processing functionality for generating and displaying the above-mentioned virtual measurement tool. Each processor 81 can be or include, for example, one or more general-purpose programmable microprocessors, digital signal processors (DSPs), mobile application processors, microcontrollers, application specific integrated circuits (ASICs), programmable gate arrays (PGAs), or the like, or a combination of such devices.

Data and instructions (code) 90 that configure the processor(s) 81 to execute aspects of the mixed-reality visualization technique introduced here can be stored in the one or more memories 82. Each memory 82 can be or include one or more physical storage devices, which may be in the form of random access memory (RAM), read-only memory (ROM) (which may be erasable and programmable), flash memory, miniature hard disk drive, or other suitable type of storage device, or a combination of such devices.

The one or more communication devices 87 enable the visualization device 71 to receive data and/or commands from, and send data and/or commands to, a separate, external processing system, such as a personal computer, a game console, or a remote server. Each communication device 88 can be or include, for example, a universal serial bus (USB) adapter, Wi-Fi transceiver, Bluetooth or Bluetooth Low Energy (BLE) transceiver, Ethernet adapter, cable modem, DSL modem, cellular transceiver (e.g., 3G, LTE/4G or 5G), baseband processor, or the like, or a combination thereof.

Display video camera(s) 84 acquire a live video feed of the user's environment, to produce the reality view of the user's environment, particularly in a conventional handheld mobile device embodiment. Tracking video camera(s) 85 can be used to detect movement (translation and/or rotation) of the visualization device 71 relative to its local environment (and particularly, relative to the target image). One or more of the tracking camera(s) 85 may be a depth-sensing camera 85, in which case the camera(s) 85 may be used to apply, for example, time-of-flight principles to determine distances to nearby objects, including the target image. The IMU 86 can include, for example, one or more gyroscope and/or accelerometers to send translation and/or rotation of the device 71. In at least some embodiments, an IMU 86 is not necessary in view of the presence of the tracking camera(s) 85, but nonetheless can be employed to provide more robust estimation.

Note that any or all of the above-mentioned components may be fully self-contained in terms of their above-described functionally; however, in some embodiments, one or more processors 81 provide at least some of the processing functionality associated with the other components. For example, at least some of the data processing for depth detection associated with tracking camera(s) 85 may be performed by processor(s) 81. Similarly, at least some of the data processing for gaze tracking associated with IMU 86 may be performed by processor(s) 81. Likewise, at least some of the image processing that supports AR/VR displays 83 may be performed by processor(s) 81; and so forth.

The machine-implemented operations described above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

### Examples of Certain Embodiments

Certain embodiments of the technology introduced herein are as summarized in the following numbered examples:

1. A method comprising: providing a user of a visualization device with a real-world, real-time view of an environment of the user, on a display area of the visualization device; determining, in the visualization device, a location at which a virtual reality window should be displayed within the real-world, real-time view of the environment of the user; and displaying, on the display area of the visualization device, the virtual reality window at the determined location within the real-world, real-time view of the environment of the user.

2. A method as recited in example 1, further comprising: generating, in the visualization device, a simulated scene of a second environment, other than the environment of the user; wherein said displaying the virtual reality window comprises displaying the simulated scene of the second environment within the virtual reality window.

3. A method as recited in example 1 or example 2, further comprising: detecting a physical movement of the visualization device; wherein said displaying the virtual reality window comprises modifying content of the virtual reality window, in the visualization device, in response to the physical movement of the visualization device, to simulate a change in perspective of the visualization device relative to the virtual reality window.

4. A method as recited in any of examples 1 through 3, wherein said determining a location at which a virtual reality window should be displayed comprises: identifying a predetermined pattern in the environment of the user; and setting the location at which a virtual reality window should be displayed, based on the predetermined pattern.

5. A method as recited in any of examples 1 through 4, wherein said displaying the virtual reality window comprises overlaying the virtual reality window over the predetermined pattern from a perspective of the visualization device.

6. A method as recited in any of examples 1 through 5, further comprising: detecting a location and orientation of the predetermined pattern; and determining a display location and orientation for the virtual reality window, based on the location and orientation of the predetermined pattern.

7. A method as recited in any of examples 1 through 6, further comprising: displaying, on the display area of the visualization device, an augmented reality image overlaid on the real-world, real-time view, outside of the virtual reality window.

8. A method as recited in any of examples 1 through 7, further comprising: displaying on the display area an object, generated by the device, so that the object appears to move from the virtual reality window to the real-world, real-time view of the environment of the user, or vice versa.

9. A method comprising: identifying, by a device that has a display capability, a first region located within a three-dimensional space occupied by a user of the device; enabling the user to view a real-time, real-world view of a portion of the three-dimensional space excluding the first region, on the device; causing the device to display to the user a virtual reality image in the first region, concurrently with said enabling the user to view the real-time, real-world view of the portion of the three-dimensional space excluding the first region; causing the device to display to the user an augmented reality image in a second region of the three-dimensional space from the point of view of the user, concurrently with said causing the device to display to the user the real-time, real-world view, the second region being outside of the first region; detecting, by the device, a changes in a location and an orientation of the device; and adjusting a location or orientation of the virtual reality image as displayed by the device, in response to the changes in the location and orientation of the display device.

10. A method as recited in example 9, wherein said identifying the first region comprises identifying a predetermined visible marker pattern in the three-dimensional space occupied by the user.

11. A method as recited in example 9 or example 10, wherein said causing the device to display the virtual reality image in the first region comprises overlaying the virtual reality image on the first region so that the first region is coextensive with the predetermined visible marker pattern.

12. A method as recited in any of examples 9 through 11, further comprising: displaying on the device an object, generated by the device, so that the object appears to move from the first region to the second region or vice versa.

13. A visualization device comprising: a display device that has a display area; a camera to acquire images of an environment in which the device is located; an inertial measurement unit (IMU); at least one processor coupled to the display device, the camera and the IMU, and configured to: cause the display device to display, on the display area, a real-world, real-time view of the environment in which the device is located; determine a location at which a virtual reality window should be displayed within the real-world, real-time view; cause the display device to display, on the display area, the virtual reality window at the determined location within the real-world, real-time view; detect a physical movement of the device based on data from at least one of the camera or the IMU; and modify content of the virtual reality window in response to the physical movement of the device, to simulate a change in perspective of the user relative to the virtual reality window.

14. A visualization device as recited in example 13, wherein the device is a hand-held mobile computing device, and the real-world, real-time view of the environment in which the device is located is acquired by the camera.

15. A visualization device as recited in example 13, wherein the device is a head-mounted AR/VR display device.

16. A visualization device as recited in any of examples 13 through 15, wherein the at least one processor is further configured to: generate a simulated scene of a second environment, other than the environment in which the device is located; wherein displaying the virtual reality window comprises displaying the simulated scene of the second environment within the virtual reality window.

17. A visualization device as recited in any of examples 13 through 16, wherein the at least one processor is further configured to: cause the display device to display, on the display area, an augmented reality image overlaid on the real-world, real-time view, outside of the virtual reality window.

18. A visualization device as recited in any of examples 13 through 17, wherein the at least one processor is further configured to: generate an object; and cause the display device to display the object on the display area so that the object appears to move from the virtual reality window to the real-world, real-time view of the environment in which the device is located, or vice versa.

19. A visualization device as recited in any of examples 13 through 18, wherein determining a location at which a virtual reality window should be displayed comprises: identifying a predetermined pattern in the environment of the user; and setting the location based on a location of the predetermined pattern.

20. A visualization device as recited in any of examples 13 through 19, wherein displaying the virtual reality window comprises overlaying the virtual reality window over the predetermined pattern from a perspective of the visualization device.

21. An apparatus comprising: means for providing a user of a visualization device with a real-world, real-time view of an environment of the user, on a display area of the visualization device; means for determining, in the visualization device, a location at which a virtual reality window should be displayed within the real-world, real-time view of the environment of the user; and means for displaying, on the display area of the visualization device, the virtual reality window at the determined location within the real-world, real-time view of the environment of the user.

22. An apparatus as recited in example 21, further comprising: means for generating, in the visualization device, a simulated scene of a second environment, other than the environment of the user; wherein said means for displaying the virtual reality window comprises means for displaying the simulated scene of the second environment within the virtual reality window.

23. An apparatus as recited in example 21 or example 22, further comprising: means for detecting a physical movement of the visualization device; wherein said means for displaying the virtual reality window comprises means for modifying content of the virtual reality window, in the visualization device, in response to the physical movement of the visualization device, to simulate a change in perspective of the visualization device relative to the virtual reality window.

24. An apparatus as recited in any of examples 21 through 23, wherein said means for determining a location at which a virtual reality window should be displayed comprises: means for identifying a predetermined pattern in the environment of the user; and setting the location at which a virtual reality window should be displayed, based on the predetermined pattern.

25. An apparatus as recited in any of examples 21 through 24, wherein said means for displaying the virtual reality window comprises means for overlaying the virtual reality window over the predetermined pattern from a perspective of the visualization device.

26. An apparatus as recited in any of examples 21 through 25, further comprising: means for detecting a location and orientation of the predetermined pattern; and means for determining a display location and orientation for the virtual reality window, based on the location and orientation of the predetermined pattern.

27. An apparatus as recited in any of examples 21 through 26, further comprising: means for displaying, on the display area of the visualization device, an augmented reality image overlaid on the real-world, real-time view, outside of the virtual reality window.

28. An apparatus as recited in any of examples 21 through 27, further comprising: means for displaying on the display area an object, generated by the device, so that the object appears to move from the virtual reality window to the real-world, real-time view of the environment of the user, or vice versa.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
providing a user of a visualization device with a real-world, real-time view of an environment of the user, on a display area of the visualization device;
determining, in the visualization device, a location at which a virtual reality window should be displayed within the real-world, real-time view of the environment of the user; and
displaying, on the display area of the visualization device, the virtual reality window at the determined location within the real-world, real-time view of the environment of the user.

2. A method as recited in claim 1, further comprising:
generating, in the visualization device, a simulated scene of a second environment, other than the environment of the user;
wherein said displaying the virtual reality window comprises displaying the simulated scene of the second environment within the virtual reality window.

3. A method as recited in claim 1, further comprising:
detecting a physical movement of the visualization device;
wherein said displaying the virtual reality window comprises modifying content of the virtual reality window, in the visualization device, in response to the physical movement of the visualization device, to simulate a change in perspective of the visualization device relative to the virtual reality window.

4. A method as recited in claim 1, wherein said determining a location at which a virtual reality window should be displayed comprises:
identifying a predetermined pattern in the environment of the user; and
setting the location at which a virtual reality window should be displayed, based on the predetermined pattern.

5. A method as recited in claim 4, wherein said displaying the virtual reality window comprises overlaying the virtual reality window over the predetermined pattern from a perspective of the visualization device.

6. A method as recited in claim 4, further comprising:
detecting a location and orientation of the predetermined pattern; and
determining a display location and orientation for the virtual reality window, based on the location and orientation of the predetermined pattern.

7. A method as recited in claim 1, further comprising:
displaying, on the display area of the visualization device, an augmented reality image overlaid on the real-world, real-time view, outside of the virtual reality window.

8. A method as recited in claim 7, further comprising:
displaying on the display area an object, generated by the device, so that the object appears to move from the virtual reality window to the real-world, real-time view of the environment of the user, or vice versa.

9. A method comprising:
identifying, by a device that has a display capability, a first region located within a three-dimensional space occupied by a user of the device;
enabling the user to view a real-time, real-world view of a portion of the three-dimensional space excluding the first region, on the device;
causing the device to display to the user a virtual reality image in the first region, concurrently with said enabling the user to view the real-time, real-world view of the portion of the three-dimensional space excluding the first region;
causing the device to display to the user an augmented reality image in a second region of the three-dimensional space from the point of view of the user, concurrently with said causing the device to display to the user the real-time, real-world view, the second region being outside of the first region;
detecting, by the device, a changes in a location and an orientation of the device; and
adjusting a location or orientation of the virtual reality image as displayed by the device, in response to the changes in the location and orientation of the display device.

10. A method as recited in claim 9, wherein said identifying the first region comprises identifying a predetermined visible marker pattern in the three-dimensional space occupied by the user.

11. A method as recited in claim 10, wherein said causing the device to display the virtual reality image in the first region comprises overlaying the virtual reality image on the first region so that the first region is coextensive with the predetermined visible marker pattern.

12. A method as recited in claim 1, further comprising:
displaying on the device an object, generated by the device, so that the object appears to move from the first region to the second region or vice versa.

13. A visualization device comprising:
a display device that has a display area;
a camera to acquire images of an environment in which the device is located;
an inertial measurement unit (IMU);
at least one processor coupled to the display device, the camera and the IMU, and configured to:
cause the display device to display, on the display area, a real-world, real-time view of the environment in which the device is located;
determine a location at which a virtual reality window should be displayed within the real-world, real-time view;
cause the display device to display, on the display area, the virtual reality window at the determined location within the real-world, real-time view;
detect a physical movement of the device based on data from at least one of the camera or the IMU; and
modify content of the virtual reality window in response to the physical movement of the device, to simulate a change in perspective of the user relative to the virtual reality window.

14. A visualization device as recited in claim 13, wherein the device is a hand-held mobile computing device, and the real-world, real-time view of the environment in which the device is located is acquired by the camera.

15. A visualization device as recited in claim 13, wherein the device is a head-mounted AR/VR display device.

16. A visualization device as recited in claim 13, wherein the at least one processor is further configured to:
generate a simulated scene of a second environment, other than the environment in which the device is located;
wherein displaying the virtual reality window comprises displaying the simulated scene of the second environment within the virtual reality window.

17. A visualization device as recited in claim 13, wherein the at least one processor is further configured to:
cause the display device to display, on the display area, an augmented reality image overlaid on the real-world, real-time view, outside of the virtual reality window.

18. A visualization device as recited in claim 17, wherein the at least one processor is further configured to:
generate an object; and
cause the display device to display the object on the display area so that the object appears to move from the virtual reality window to the real-world, real-time view of the environment in which the device is located, or vice versa.

19. A visualization device as recited in claim 13, wherein determining a location at which a virtual reality window should be displayed comprises:
identifying a predetermined pattern in the environment of the user; and
setting the location based on a location of the predetermined pattern.

20. A visualization device as recited in claim 19, wherein displaying the virtual reality window comprises overlaying the virtual reality window over the predetermined pattern from a perspective of the visualization device.
